(19) United States
(12) Patent Application Publication
(10) Pub. No.: US 2023/0013527 A1
(43) Pub. Date: Jan. 19, 2023

(54) DECAYING SCORES TO RANK ARTISTS

(71) Applicant: REVVSTREET INC., Chicago, IL (US)

(72) Inventor: Nathan M. Hollerbach, Chicago, IL (US)

(21) Appl. No.: 17/864,498

(22) Filed: Jul. 14, 2022

Related U.S. Application Data
(60) Provisional application No. 63/222,882, filed on Jul. 16, 2021.

(51) Int. Cl. A63F 13/814; A63F 13/798; A63F 13/46

(52) U.S. Cl. CPC A63F 13/814; A63F 13/798; A63F 13/46; A63F 2300/8047; A63F 2300/558

(57) ABSTRACT

A system may be configured to generate a leaderboard. Content may be presented via each of a plurality of contestants to a plurality of displays of a plurality of users. A plurality of votes may be obtained based on each of the presentations. A score may be determined for each of the contestants based on the respective votes. Each of the scores may be reduced based on an amount of elapsed time since the respective determination. Finally information identifying the contestant having the highest score may be output.

### CROSS REFERENCE TO RELATED APPLICATIONS

This application claims the benefit of U.S. Provisional Patent App. No. 63/222,882, filed Jul. 16, 2021, the disclosure of which is hereby incorporated by reference herein.

### TECHNICAL FIELD

The present disclosure generally relates to systems and methods for ranking artists.

### BACKGROUND

There currently exists an explosion of content, with relatively unknown artists suffering a survivorship bias in the market. For example, only the top 5-10% of artists get national recognition. Arbiters driving this recognition have an inefficient and overly centralized process. Thus, artists have trouble receiving recognition to connect with new fans, and fans reciprocally have trouble discovering new content.

### SUMMARY

Systems and methods are disclosed for aggregating artists , by holding a visible, competitive event responsive to which their scores are continually updated in real-time. Accordingly, some embodiments may: present, via each of a plurality of contestants to a plurality of displays of a plurality of users, content; obtain, based on each of the presentations, a plurality of votes; determine, for each of the contestants based on the respective votes, a score; reduce, based on an amount of elapsed time since the respective determination, each of the scores; and output information identifying the contestant having the highest score.

The method is implemented by a system comprising one or more hardware processors configured by machine-readable instructions and/or other components. The system comprises the one or more processors and other components or media, e.g., upon which machine-readable instructions may be executed. Implementations of any of the described techniques and architectures may include a method or process, an apparatus, a device, a machine, a system, or instructions stored on computer-readable storage device(s).

### BRIEF DESCRIPTION OF THE DRAWINGS

The details of particular implementations are set forth in the accompanying drawings and description below. Like reference numerals may refer to like elements throughout the specification. Other features will be apparent from the following description, including the drawings and claims. The drawings, though, are for the purposes of illustration and description only and are not intended as a definition of the limits of the disclosure.

FIG. 1 illustrates an example of a system in which performing artists can be identified as trendy, in accordance with one or more embodiments.

FIG. 2 illustrates an example of a user interface at which a user is operable to interact with competitive content, in accordance with one or more embodiments.

FIG. 3A illustrates an example of a user interface at which a user is operable to observe a current leader, in accordance with one or more embodiments.

FIG. 3B illustrates an example of a user interface at which a user is operable to observe an artist's profile, observe their content, and interact with social media accounts, in accordance with one or more embodiments.

FIG. 4 illustrates a process for decaying scores to eliminate the survivorship bias and discover new music, in accordance with one or more embodiments.

### DETAILED DESCRIPTION

Present ways of generating a leaderboard of artists and implementing a music-based sporting league (e.g., within one or more genres, such as hip hop) are disclosed. The more artists contribute to their own growth by showcasing their talent in contests and/or by sharing their profile with their fans, the more likely this artist can earn personalized marketing kits and/or other promotion. Top artists may earn paid media campaigns, live show bookings, national media exposure, exclusive deals, cash prizes, and/or stand out for industry executives looking for talent.

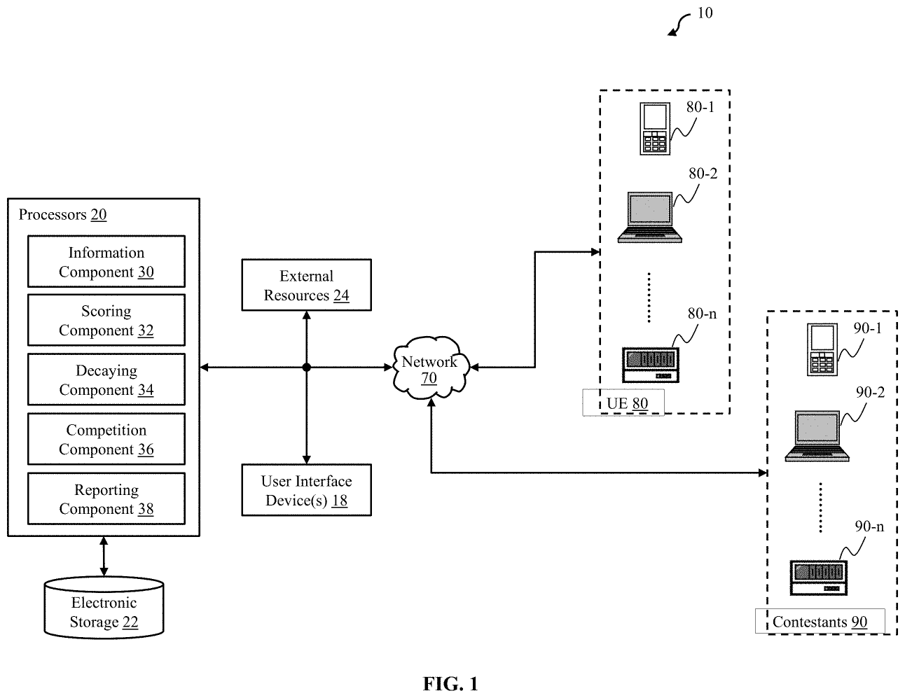

FIG. 1 discloses system 10, which comprises example structure that enables artists (e.g., contestants 90 or other entertainers) to obtain a sufficient amount of votes to be rewarded with leveraged functionality of the underlying platform and its resources. In some embodiments, processors 20 may provide a platform, web portal, and/or software application to artists 90 and their fans 80.

In some embodiments, information component 30 may organize each artist 90 into a region (e.g., neighborhood, village, city, state/province, country, or another set of locations) and/or into another categorization (e.g., demographic, market, or another class). For example, each region may have a different set of artists. Then, scoring component 32 may aggregate views/votes for that time period (e.g., a day) and rank them based on the total count. As a result, new or unknown content of artist 90 may be discovered via interaction from the online audience (e.g., via user equipment (UE) 80).

In some embodiments, information component 30 may onboard artists 90 by obtaining their name, region, photo, and/or social media account information, to generate their profile; similarly, each device 80 of the fans/users may become registered, the locations of each of the foregoing being input via a form or based on a location determined by a positioning system (e.g., GPS). Each artist may then be allowed to upload content (e.g., audio and/or video files), share a link to their profile, and/or use their personal marketing tools to reach their fans and accumulate profile points. And artist 90 may participate in live events 93, e.g., to release new songs and win more profile points. Upon reaching the top of this private network (e.g., with the number of points breaching a threshold), the artist may obtain exclusive profile boosts and/or unlock new marketing and promotion that system 10 may subsequently perform for the artist.

Every participant viewing the artist's work can vote on content from the artist 90. Each participant can have a certain number votes per time period. For example, every participant may have ten votes per day. Initially, each vote by a participant may be worth a single point. However, the weight associated with the participant's vote can increase based on activity from the participant. For example, the greater than quantity of times that the participant votes in a predetermined time period, the higher the points associated with each vote for that participant. For example, if a participant votes 70 times a week, each vote from that participant may be worth 4 points, whereas if another participant votes 40 times a week, each vote from that participant may be worth two points, and whereas still if another participant votes 10 times a week, each vote from that participant may be only worth a single point. As such the points associated with each artist are based on the number of votes they receive and characteristics of the participants that cast the votes.

In some embodiments, information component 30 may facilitate user notifications, e.g., when artist 90 thanks a user, when a reminder for an upcoming event is sent, and/or when a new artist registers for the platform.

In some implementations, each artist may be a standalone player in the league. In other implementations, each artist may form part of a team (e.g., with marquee contestant 90 acting as the captain) such that players' scores may be rolled up into a final score for the team. Over the course of a few months, e.g., the contestants may be forced to come up with new content for promoting of the content and subsequent user voting to increase their profile point total.

In some implementations, information component 30 may invite 10 artists per city to participate. For example, contestant 90 may submit a music video from their profile to be in one of the contests 93. And then in about two weeks, e.g., a whole new set of contestants 90 may compete. In some embodiments, voting is enabled at all times such that artist 90 can still make it to the top without even being in a contest just by sharing 98 their deeplink.

In some embodiments, scoring component 32 may determine, for each of contestants 90 based on the respective votes, score 92. For example, each day views, votes, and/or profile-points (e.g., from UE 80 and/or other devices) may be combined and processed to arrive at a total count for each of the artists. And this cumulative count may be reduced by a decay coefficient, as time passes. The scores of each artists' profile may be accumulated and ranked in a dynamically updated leaderboard. The resultant, decayed score may be placed on the leaderboard or ranking. And this leaderboard may create a situation to gamify artist participation, e.g., by effectively creating a new way for artists to get paid to change the structure of the industry altogether.

In some embodiments, decaying component 34 may determine a ranking based on decayed or reduced total counts. In these or other embodiments, reporting component 38 may output scoring information that causes the identified contestant to overcome a survivorship bias. For example, reporting component 38 may implement a ranking system or a leaderboard such that, in the presence of marquee artist(s) (e.g., who may instantly receive millions of votes) of region(s), a substantially more unknown artist or disc jockey (DJ) (e.g., who has 3,000 followers) of a region may be able to veritably compete with the marquee artist(s) and become more known by the herein-disclosed means for trending. In this or another example, if Jay-Z were to join the platform or network and quickly get a million votes, he would be at the top of the leaderboard; but, if he does not continually get those votes, those votes would decay quickly such that he eventually goes far down the ranking.

Via a decaying algorithm, votes may count as X today but those votes an amount of time later may be reduced to less than X using a coefficient. As such, decaying component 34 may perform reductions using the coefficient such that a total count of a less recent score is valued less than a total count of a more recent score. For example, the value of today's votes can become half as much just a day or two (or a week or two) later. In some embodiments, the decay coefficient may be based on time. For example, a total score may be dynamically transformed or updated over time into an asymptotic line, e.g., by multiplying the score by 0.5 raised to the power of t (time). In this or another example, the total count may be decayed by the minute, hour, or at another configurable interval.

In some embodiments, the coefficient may be adjusted, e.g., to drive the users' interactions. And the adjustment of the coefficient may, e.g., help to cause users to experience newer artists and/or newer content.

In some embodiments, decaying component 34 may determine a ranking using a decaying algorithm across multiple timelines (lookback period), to identify hyper-localized trending artists. As such, today's votes may be worth more than yesterday's votes, to reduce the survivorship-bias that is currently affecting the (e.g., music) industry. By performing well in periodic (e.g., weekly), scheduled (e.g., at an irregular rate), or impromptu contests and/or by using the deeplinks to distribute directly to their fans, artists 90 can cause themselves to rise up quickly and get boosted up the charts via the disclosed scoring system. And this scoring system may be based on the aforementioned time-decay and a lookback period. For example, the updating of the scores may be at different intervals, e.g., every minute, hour, day, or at another rate (e.g., with the decaying being adjusted based on time). And this decaying may only be for a predetermined, prior time period, (e.g., with any existing scores older than this period being devalued substantially to zero).

In some embodiments, the scores may be based on content views, profile votes, contest votes, and/or another metric. For example, by winning and/or competing in weekly music contests, artist 90 may earn profile points.

In some embodiments, decaying component 34 may reduce past scores such that a contestant is operable to become trendy or be highlighted. As such, artist 90 in region 91 (e.g., for a contest) not having a national following may be able to obtain at least a substantial amount of exposure. And this artist may be able to further their interest, by performing beautifully (e.g., musically, visually, etc.) in contest 93 and/or by communicatively sharing 98 their profile with others using the deeplink.

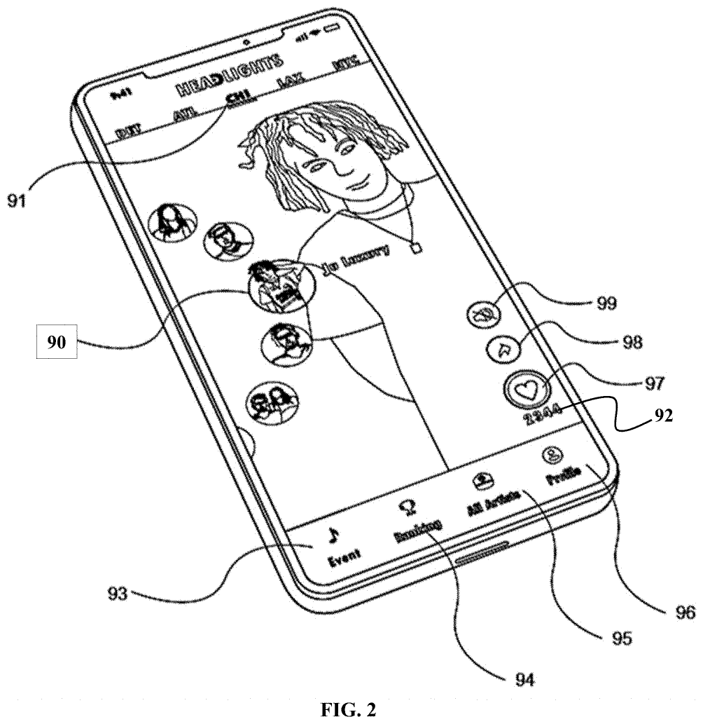

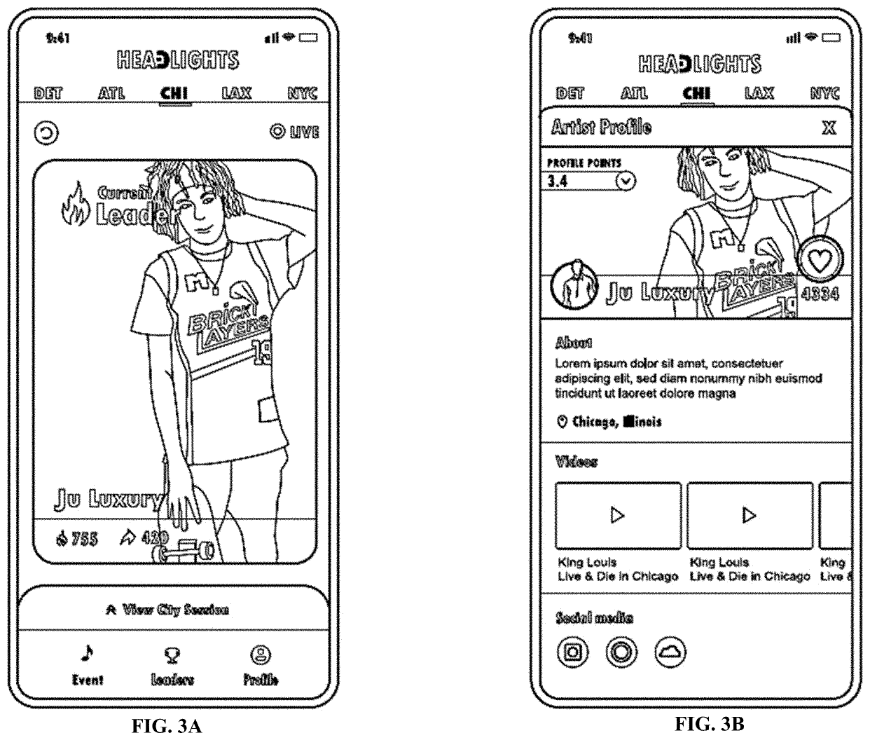

In some embodiments, competition component 36 may obtain, via a user at UE 80 swiping left or right on a user interface, a selection of a different region to obtain information on a different plurality of contestants 90. As disclosed in the example of FIG. 2, region 91 may be selected in a same user interface in which a contestant of the region is selected. For example, after this selection is made, the user can then view a city session, contest, or event, which may occur over a short-term period (e.g., 4 days). And, by performing a profile selection at the user interface, the user may indicate contestant(s) 90 to obtain information descriptive of or content performed by the indicated contestant, as shown in FIG. 3B.

FIG. 2 further depicts an ability for a user to select other contestants 90 (e.g., by cyclically rotating through bubblelike representations of those that are participating in the event), to vote 97 for a contestant 90, to promote 98 contestant 90, to navigate to event 93, to navigate to leaderboard (ranking) 94, to see a listing of artists 95 (e.g., all of the region or all in the platform), to see profile 96 of an artist, and to mute 99 music being played at UE 80.

In some embodiments, competition component 36 may enable each of the artists in a region to compete in event 93 by performing (e.g., musically) online. In these or other embodiments, each of the events 93 may be held globally at each of the regions 91. These contests 93 may serve, e.g., as a catalyst and focal point by bringing artists together. For example, competition component 36 may facilitate a global hip hop competition, a different plurality of contestants 90 being in each of a plurality of different regions 91. In this or another example, competition 93 may be held as part of a season, a winner thereof being substantially marketed. That is, reporting component 38 may send information to one or more external news sites and/or one or more social media venues. A real world process may thus be implemented, e.g., by filtering and suggesting artists that have successfully gone through this filter.

In some embodiments, reporting component 38 may cause an easier way for artists (e.g., new artists or artists who recently have not been among the ranked leaders) to be discovered by fans and industry stakeholders. For example, this component may output information identifying a contestant having a highest score (e.g., in a predetermined and/or configurable time period). This score may be determined by performing a reduction (e.g., over the time period). And each of the scores may be reduced based on an amount of time elapsed since the respective score was determined.

In some embodiments, as an artist moves up the ranking, reporting component 38 may broadcast this artist to a much wider group of targeted fans. This wider reach may be facilitated via promoting at different social media accounts and/or news channels (e.g., at rap.com, Instagram, Twitter, Facebook, Snapchat, TikTok, YouTube, Spotify, Apple Music, Soundcloud, etc.). As such, a number one or otherwise trending artist of a region may be promoted or published to those outside of the disclosed platform. For example, a winner of a regional or global leaderboard may be broadcast and/or otherwise supported with media to figuratively put their new music on the map. As such, reporting component 38 may perform cross platform artist promotion (e.g., to external platforms that have agreed to pick up as news these local, trending artists). For example, results of contests of the disclosed platform may be outputted via broadcast or multicast means. In another example, artists that hustle can have the heavy lifting of marketing be done on their own music out across a wide spectrum of different media, social and otherwise.

In some embodiments, artists may hustle using the disclosed platform, e.g., by getting their fans to rally behind them by becoming registered users and voting. For example, the voting may be performed in a short time frame (e.g., in a two-day period) such that the artist pops up to then be promoted. Accordingly, in addition to or instead of being a contestant in a contest, an artist may use a deeplink to engage directly with their fans to boost themselves up the leaderboard and unlock different levels of support and/or promotion. For example, reporting component 38 may promote the top five artists at the end of each week, promote the top one any time the number one position in the ranking changes, and/or promote an artist that jumped up many positions in the ranking.

The deeplink may thus function to collect votes and/or views and to connect with fans, e.g., by sharing the artist's views, votes, and streaming data. In some embodiments, when artist 90 shares 98 a deeplink to a user, the recipient user may be taken to the application itself (e.g., on Android or iOS), if this user was already registered, or otherwise to a web portal hosting the herein disclosed functionality. This demonstrates one instance in which the user may be operable to vote 97 for artist 90.

As depicted in the example of FIG. 3A, a local, trending artist (e.g., by reporting one or more popped-up artists) may be identified for highlighting. For example, by a user clicking on “ranking” or “leaders” 94 at the bottom of a user interface, a current leader or the current leaders of a ranking may be displayed (e.g., before, at the end of, or during a live event). In this or another example, contestant 90 may be displayed with an image, their current (decayed) score 92, their region 91, and/or a number of times a deeplink to this profile has been shared to users/fans. As such, an artist's voice may be amplified via fan-driven leaderboards. In some implementations, UE 80 may only vote for contestants 90 near their own location. In other implementations, UE 80 may vote for contestants 90 of other regions, e.g., by browsing from city to city.

Although only one artist is depicted in leaderboard 94 of FIG. 3A, this is not intended to be limiting, as two, three, four, five, six, seven, or another number of artists is contemplated to be listed in a top tier of the ranking.

In some embodiments, when contest 93 begins, each user 80 may be allowed to make a certain number of votes. Each time the user votes or shares a deeplink to a profile, the user may earn points. Eventually, those votes will help the user boost their strength, while at the same time potentially increasing visibility to the voted on artist. As such, the more the user votes, the more influence they gain (e.g., to the point of actually influencing the music industry via powerful votes). The votes may be replenished, e.g., every 15 minutes. And a user's votes may be specific to a region.

In some embodiments, when a user clicks on a deeplink via their UE 80, the user may be brought to an online profile page 96, as depicted in the example of FIG. 3B. For example, each artist 90 may post at least a portion of their content (e.g., to their profile page 96) and have it featured and available for user consumption. In this or another example, the user may vote for one or more of the content, the voting being attributed to the artist. Voting may thus be for the song and/or for the artist, depending on the type of competition.

In some embodiments, the disclosed scoring system may be based on a longer-term season. For example, scoring component 32 may take a snapshot of an artist's ranking or score at 8 PM each day, and this component may keep track of the ranking or score each day for 8 months. At the end of the 8 months, artist 90 with the highest score or ranking overall may win (e.g., a share of sponsorship revenue).

In some embodiments, the voting, the scores, records of the forwards, and historical rankings may be stored in a decentralized and unalterable blockchain (e.g., which may be implemented via information component 30).

Electronic storage 22 of FIG. 1 comprises electronic storage media that electronically stores information. The electronic storage media of electronic storage 22 may comprise system storage that is provided integrally (i.e., substantially non-removable) with system 10 and/or removable storage that is removably connectable to system 10 via, for example, a port (e.g., a USB port, a firewire port, etc.) or a drive (e.g., a disk drive, etc.). Electronic storage 22 may be (in whole or in part) a separate component within system 10, or electronic storage 22 may be provided (in whole or in part) integrally with one or more other components of system 10 (e.g., a user interface device 18, processor 20, etc.). In some embodiments, electronic storage 22 may be located in a server together with processor 20, in a server that is part of external resources 24, in user interface devices 18, and/or in other locations. Electronic storage 22 may comprise a memory controller and one or more of optically readable storage media (e.g., optical disks, etc.), magnetically readable storage media (e.g., magnetic tape, magnetic hard drive, floppy drive, etc.), electrical charge-based storage media (e.g., EPROM, RAM, etc.), solid-state storage media (e.g., flash drive, etc.), and/or other electronically readable storage media. Electronic storage 22 may store software algorithms, information obtained and/or determined by processor 20, information received via user interface devices 18 and/or other external computing systems, information received from external resources 24, and/or other information that enables system 10 to function as described herein.

External resources 24 may include sources of information (e.g., databases, websites, etc.), external entities participating with system 10, one or more servers outside of system 10, a network, electronic storage, equipment related to Wi-Fi technology, equipment related to Bluetooth® technology, data entry devices, a power supply (e.g., battery powered or line-power connected, such as directly to 110 volts AC or indirectly via AC/DC conversion), a transmit/receive element (e.g., an antenna configured to transmit and/or receive wireless signals), a network interface controller (NIC), a display controller, a graphics processing unit (GPU), and/or other resources. In some implementations, some or all of the functionality attributed herein to external resources 24 may be provided by other components or resources included in system 10. Processor 20, external resources 24, user interface device 18, electronic storage 22, a network, and/or other components of system 10 may be configured to communicate with each other via wired and/or wireless connections, such as a network (e.g., a local area network (LAN), the Internet, a wide area network (WAN), a radio access network (RAN), a public switched telephone network (PSTN), etc.), cellular technology (e.g., GSM, UMTS, LTE, 5G, etc.), Wi-Fi technology, another wireless communications link (e.g., radio frequency (RF), microwave, infrared (IR), ultraviolet (UV), visible light, cm wave, mm wave, etc.), a base station, and/or other resources.

User interface device(s) 18 of system 10 may be configured to provide an interface between one or more users and system 10. User interface devices 18 are configured to provide information to and/or receive information from the one or more users. User interface devices 18 include a user interface and/or other components. The user interface may be and/or include a graphical user interface configured to present views and/or fields configured to receive entry and/or selection with respect to particular functionality of system 10, and/or provide and/or receive other information. In some embodiments, the user interface of user interface devices 18 may include a plurality of separate interfaces associated with processors 20 and/or other components of system 10. Examples of interface devices suitable for inclusion in user interface device 18 include a touch screen, a keypad, touch sensitive and/or physical buttons, switches, a keyboard, knobs, levers, a display, speakers, a microphone, an indicator light, an audible alarm, a printer, and/or other interface devices. The present disclosure also contemplates that user interface devices 18 include a removable storage interface. In this example, information may be loaded into user interface devices 18 from removable storage (e.g., a smart card, a flash drive, a removable disk) that enables users to customize the implementation of user interface devices 18.

In some embodiments, user interface devices 18 are configured to provide a user interface, processing capabilities, databases, and/or electronic storage to system 10. As such, user interface devices 18 may include processors 20, electronic storage 22, external resources 24, and/or other components of system 10. In some embodiments, user interface devices 18 are connected to a network (e.g., the Internet). In some embodiments, user interface devices 18 do not include processor 20, electronic storage 22, external resources 24, and/or other components of system 10, but instead communicate with these components via dedicated lines, a bus, a switch, network, or other communication means. The communication may be wireless or wired. In some embodiments, user interface devices 18 are laptops, desktop computers, smartphones, tablet computers, and/or other user interface devices.

Data and content may be exchanged between the various components of the system 10 through a communication interface and communication paths using any one of a number of communications protocols. In one example, data may be exchanged employing a protocol used for communicating data across a packet-switched internetwork using, for example, the Internet Protocol Suite, also referred to as TCP/IP. The data and content may be delivered using datagrams (or packets) from the source host to the destination host solely based on their addresses. For this purpose the Internet Protocol (IP) defines addressing methods and structures for datagram encapsulation. Of course other protocols also may be used. Examples of an Internet protocol include Internet Protocol version 4 (IPv4) and Internet Protocol version 6 (IPv6).

In some embodiments, processor(s) 20 may form part (e.g., in a same or separate housing) of a user device, a consumer electronics device, a mobile phone, a smartphone, a personal data assistant, a digital tablet/pad computer, a wearable device (e.g., watch), augmented reality (AR) goggles, virtual reality (VR) goggles, a reflective display, a personal computer, a laptop computer, a notebook computer, a work station, a server, a high performance computer (HPC), a vehicle (e.g., embedded computer, such as in a dashboard or in front of a seated occupant of a car or plane), a game or entertainment system, a set-top-box, a monitor, a television (TV), a panel, a space craft, or any other device. In some embodiments, processor 20 is configured to provide information processing capabilities in system 10. Processor 20 may comprise one or more of a digital processor, an analog processor, a digital circuit designed to process information, an analog circuit designed to process information, a state machine, and/or other mechanisms for electronically processing information. Although processor 20 is shown in FIG. 1 as a single entity, this is for illustrative purposes only. In some embodiments, processor 20 may comprise a plurality of processing units. These processing units may be physically located within the same device (e.g., a server), or processor 20 may represent processing functionality of a plurality of devices operating in coordination (e.g., one or more servers, user interface devices 18, devices that are part of external resources 24, electronic storage 22, and/or other devices).

In some embodiments, UE 80 may each form part of and artists 90 may each perform in relation to a user device, a consumer electronics device, a mobile phone, a smartphone, a personal data assistant, a digital tablet/pad computer, a wearable device, AR goggles, VR goggles, a reflective display, a personal computer, a laptop computer, a notebook computer, a work station, a server, an HPC, a vehicle, a game or entertainment system, a set-top-box, a monitor, a TV, a panel, a space craft, or any other device.

As shown in FIG. 1, processor 20 is configured via machine-readable instructions to execute one or more computer program components. The computer program components may comprise one or more of information component 30, scoring component 32, decaying component 34, competition component 36, reporting component 38, and/or other components. Processor 20 may be configured to execute components 30, 32, 34, 36, and/or 38 by: software; hardware; firmware; some combination of software, hardware, and/or firmware; and/or other mechanisms for configuring processing capabilities on processor 20.

It should be appreciated that although components 30, 32, 34, 36, and 38 are illustrated in FIG. 1 as being co-located within a single processing unit, in embodiments in which processor 20 comprises multiple processing units, one or more of components 30, 32, 34, 36, and/or 38 may be located remotely from the other components. For example, in some embodiments, each of processor components 30, 32, 34, 36, and 38 may comprise a separate and distinct set of processors. The description of the functionality provided by the different components 30, 32, 34, 36, and/or 38 described below is for illustrative purposes, and is not intended to be limiting, as any of components 30, 32, 34, 36, and/or 38 may provide more or less functionality than is described. For example, one or more of components 30, 32, 34, 36, and/or 38 may be eliminated, and some or all of its functionality may be provided by other components 30, 32, 34, 36, and/or 38. As another example, processor 20 may be configured to execute one or more additional components that may perform some or all of the functionality attributed below to one of components 30, 32, 34, 36, and/or 38.

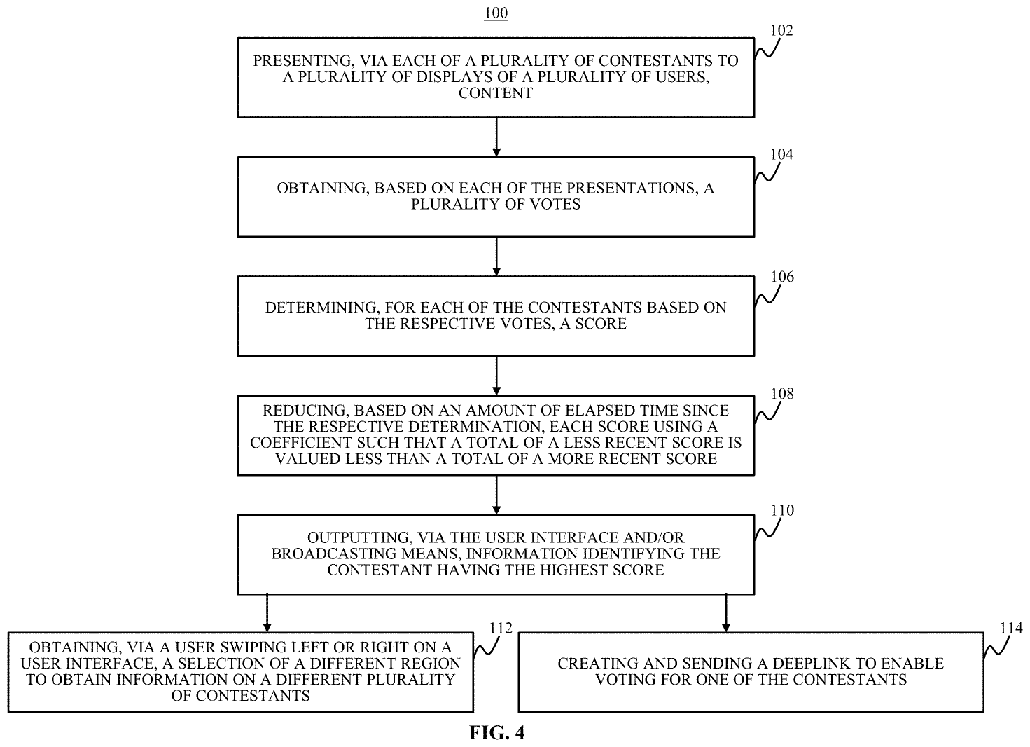

FIG. 4 illustrates method 100 for developing a scoring system driven by the fans of artists, in accordance with one or more embodiments. Method 100 may be performed with a computer system comprising one or more computer processors and/or other components. The processors are configured by machine readable instructions to execute computer program components. The operations of method 100 presented below are intended to be illustrative. In some embodiments, method 100 may be accomplished with one or more additional operations not described, and/or without one or more of the operations discussed. Additionally, the order in which the operations of method 100 are illustrated in FIG. 4 and described below is not intended to be limiting. In some embodiments, method 100 may be implemented in one or more processing devices (e.g., a digital processor, an analog processor, a digital circuit designed to process information, an analog circuit designed to process information, a state machine, and/or other mechanisms for electronically processing information). The processing devices may include one or more devices executing some or all of the operations of method 100 in response to instructions stored electronically on an electronic storage medium. The processing devices may include one or more devices configured through hardware, firmware, and/or software to be specifically designed for execution of one or more of the operations of method 100.

At operation 102 of method 100, audiovisual content may be presented, e.g., via artistic performance of each of a plurality of contestants captured and transmitted to a plurality of displays of a plurality of users. In some embodiments, operation 102 is performed by a processor component the same as or similar to information component 30 (shown in FIG. 1 and described herein).

At operation 104 of method 100, a plurality of votes may be obtained, e.g., with the votes being made by users based on each of the presentations. As an example, the heart, fire, or like icon 97 of a user interface may be selected. In some embodiments, operation 102 is performed by a processor component the same as or similar to information component 30 (shown in FIG. 1 and described herein).

At operation 106 of method 100, a score may be determined, for each of the contestants, based on the respective votes. As an example, each of the score determinations may be based on a total count of the respective votes currently made for artist A. In some embodiments, operation 102 is performed by a processor component the same as or similar to scoring component 32 (shown in FIG. 1 and described herein).

At operation 108 of method 100, each of the scores may be reduced (e.g., using a coefficient) based on an amount of elapsed time since the respective determination. As an example, the current score for artist A may be dynamically determined by this decaying to be (e.g., progressively) worth less over time (e.g., with a score from an hour or day ago being substantially worth less than a score from a week or month ago). As such, a cumulative total of a less recent score may be decayed more than a cumulative total of a more recent score. In some embodiments, operation 102 is performed by a processor component the same as or similar to decaying component 34 (shown in FIG. 1 and described herein).

At operation 110 of method 100, information identifying the contestant having the highest score may be outputted, via the user interface and/or broadcasting means. As an example, the (e.g., decayed) scores may be output (e.g., to a user, the artist, one or more social media outlets, one or more news outlets, and/or an industry stakeholder) in a ranking, each potentially decayed score being associated with the respective contestant or artist. In this or another example, reporting component 38 may output information identifying another contestant having a more recently determined highest score (e.g., where this more recently determined highest score of the other contestant being greater than the highest score of the contestant due to the decaying or reduction). In some embodiments, operation 102 is performed by a processor component the same as or similar to reporting component 38 (shown in FIG. 1 and described herein).

At operation 112 of method 100, a selection of a different region may be obtained, via a user swiping (e.g., left, right, up, down, or diagonally) on a user interface, to obtain information on a different plurality of contestants. As an example, there may be 6 contestants competing (e.g., live at an online or in-person event) in Chicago, and another 6 contestants may be simultaneously competing (e.g., live at an online or in-person event) in each of Detroit, Atlanta, Los Angeles, and New York City. In some embodiments, operation 102 is performed by a processor component the same as or similar to competition component 36 (shown in FIG. 1 and described herein).

At operation 114 of method 100, a link or hyperlink may be created and sent, e.g., to enable voting for one artist 90. In some embodiments, operation 102 is performed by a processor component the same as or similar to information component 30 (shown in FIG. 1 and described herein).

Techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device, in machine-readable storage medium, in a computer-readable storage device or, in computer-readable storage medium for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques can be performed by one or more programmable processors executing a computer program to perform functions of the techniques by operating on input data and generating output. Method steps can also be performed by, and apparatus of the techniques can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, such as, magnetic, magneto-optical disks, or optical disks. Information carriers suitable for embodying computer program instructions and data include all forms of non-volatile memory, including by way of example semiconductor memory devices, such as, EPROM, EEPROM, and flash memory devices; magnetic disks, such as, internal hard disks or removable disks; magneto-optical disks; and CD-ROM and DVD-ROM disks. The processor and the memory can be supplemented by, or incorporated in special purpose logic circuitry.

Several embodiments of the disclosure are specifically illustrated and/or described herein. However, it will be appreciated that modifications and variations are contemplated and within the purview of the appended claims.

What is claimed is:

1. A method for generating a leaderboard, the method comprising:
presenting, via each of a plurality of contestants to a plurality of displays of a plurality of users, content;
obtaining, based on each of the presentations, a plurality of votes;
determining, for each of the contestants based on the respective votes, a score;
reducing, based on an amount of elapsed time since the respective determination, each of the scores; and
outputting information identifying the contestant having the highest score.

2. The method of claim 1, wherein each of the determinations is based on a total count of the respective votes.

3. The method of claim 2, further comprising:
performing the reductions using a coefficient such that the total count of a less recent score is valued less than the total count of a more recent score.

4. The method of claim 3, wherein the reductions are performed over a predetermined, past period of time.

5. The method of claim 1, further comprising:
obtaining, via a user swiping left or right on a user interface, a selection of a different region to obtain information on a different plurality of contestants.

6. The method of claim 1, wherein each of the contestants is associated with a predetermined region, and
wherein each of the contestants is a contestant in an event of a musical genre.

7. The method of claim 1, further comprising:
creating a link; and
sending the link to enable at least one of the votes.

8. The method of claim 1, wherein the outputting causes the identified contestant to overcome a survivorship bias.

9. The method of claim 1, further comprising:
sending the information to one or more external news sites and/or one or more social media venues.

10. The method of claim 1, wherein the presentations form part of a competitive season.

11. The method of claim 1, further comprising:
outputting, in a ranking, the scores each in an association with the respective contestant.

12. The method of claim 5, further comprising:
obtaining, via the user indicating one of the contestants at the user interface, information descriptive of or content performed by the one indicated contestant.

13. The method of claim 1, further comprising:
outputting information identifying another contestant having a more recently determined highest score.

14. The method of claim 1, wherein an event comprising the contestants is performed globally, via a different plurality of contestants in each of a plurality of different regions.

15. A non-transitory computer-readable medium comprising instructions executable by at least one processor to perform a method, the method comprising:
presenting, via each of a plurality of artists to a plurality of displays of a plurality of users, content;
creating a link;
obtaining, based on each of the presentations, a plurality of votes;
sending the link to enable at least one of the votes;
determining, for each of the artists based on the respective votes, a score; and
reducing, based on an amount of elapsed time since the respective determination, each of the scores.

16. The medium of claim 15, wherein each of the determinations is based on a total count of the respective votes.

17. The medium of claim 16, wherein the method further comprises:
performing the reductions using a coefficient such that the total count of a less recent score is valued less than the total count of a more recent score.

18. The medium of claim 17, wherein the reductions are performed over a predetermined, past period of time.

19. The medium of claim 15, wherein the method further comprises:
obtaining, via a user swiping left or right on a user interface, a selection of a different region to obtain information on a different plurality of artists.

20. The medium of claim 15, wherein each of the artists is associated with a predetermined region, and
wherein each of the artists is a performer in a musical genre.
